(19) United States
(12) Patent Application Publication
(10) Pub. No.: US 2026/0012763 A1
(43) Pub. Date: Jan. 8, 2026

(54) METHODS, ARCHITECTURES, APPARATUSES AND SYSTEMS FOR SENSING

(71) Applicant: InterDigital Patent Holdings, Inc., Wilmington, DE (US)

(72) Inventors: Ognen Ognenoski, London (GB); Filipe Conceicao, London (GB); Alain Mourad, Ascot (GB); Javier Lorca Hernando, Madrid (ES); Yasser Mestrah, Uxbridge (GB); Arman Shojaeifard, London (GB); Mohammad Heggo, Lewisham (GB); Muhammad Awais Jadoon, London (GB)

(21) Appl. No.: 18/763,254

(22) Filed: Jul. 3, 2024

(51) Int. Cl. H04W 4/38; H04L 5/00

(52) U.S. Cl. CPC H04W 4/38; H04L 5/0048

(57) ABSTRACT

Systems and methods are provided for providing sensing features. A WTRU receives first configuration information indicative of a CSI-RS sub-band configuration, at least one first criterion and at least one second criterion. The WTRU performs channel state estimation measurements on a plurality of CSI-RS resources, identifies a set of sub-band options from the CSI-RS resources that satisfy the at least one first criterion based at least in part on the channel state estimation measurements and on the CSI-RS sub-band configuration, identifies a subset of the identified set of sub-band options that satisfy the at least one second criterion, and transmits, to the wireless network, a sub-band request. The WTRU receives, from the wireless network based on the sub-band request, second configuration information indicative of which of the plurality of CSI-RS resources are to be used for sensing measurements and performs the sensing measurements based on the second configuration information.

### BACKGROUND

The present disclosure is generally directed to the fields of communications, software and encoding, including, for example, to methods, architectures, apparatuses, systems related to a sensing task.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a system diagram according to one or more embodiment;

FIG. 3 illustrate a CSI-RS structure according to one or more embodiment;

FIG. 4 is a flow chart illustrating a process according to one or more embodiment;

FIG. 5 is a flow chart illustrating a method according to one or more embodiment;

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

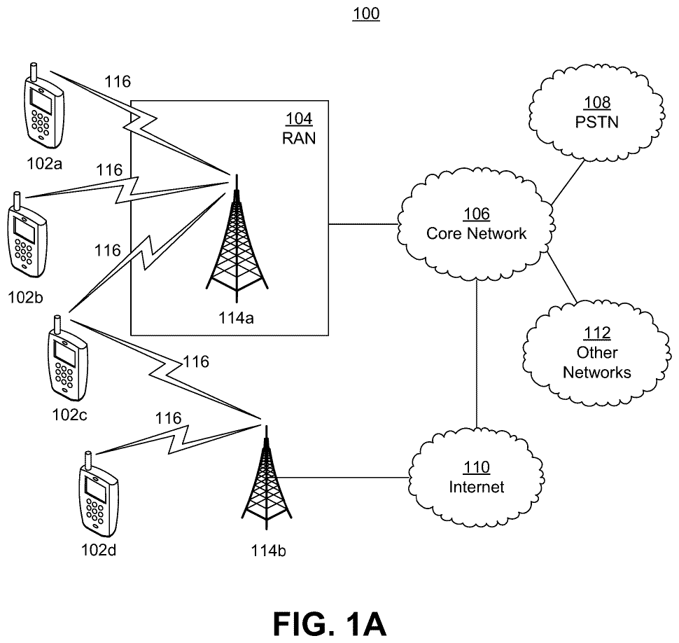

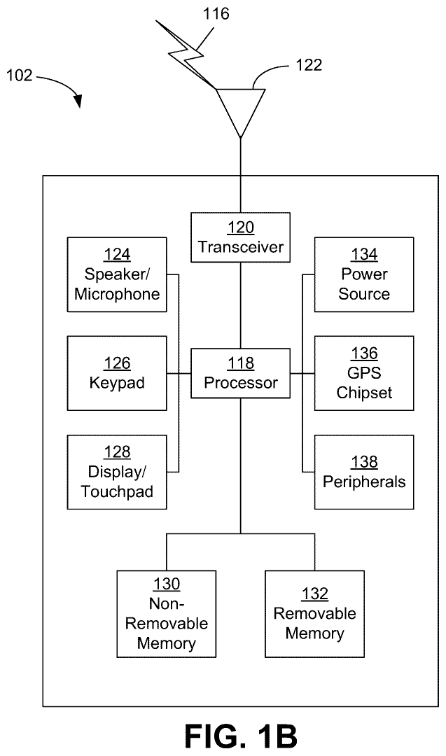

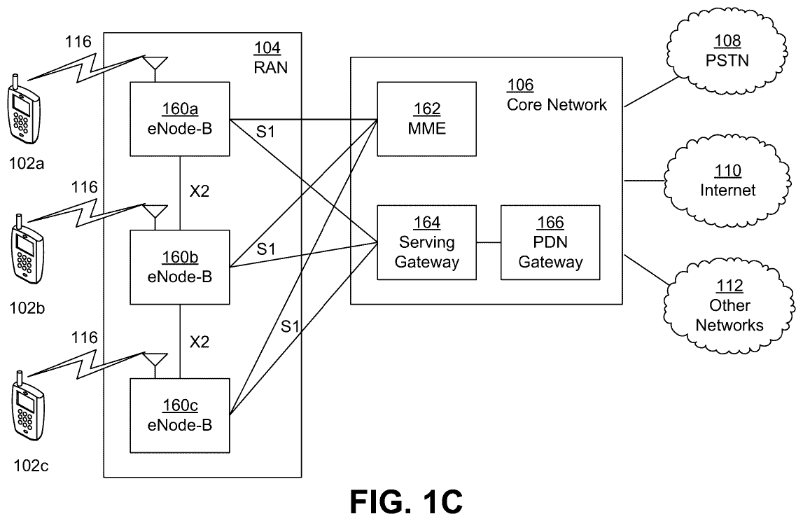

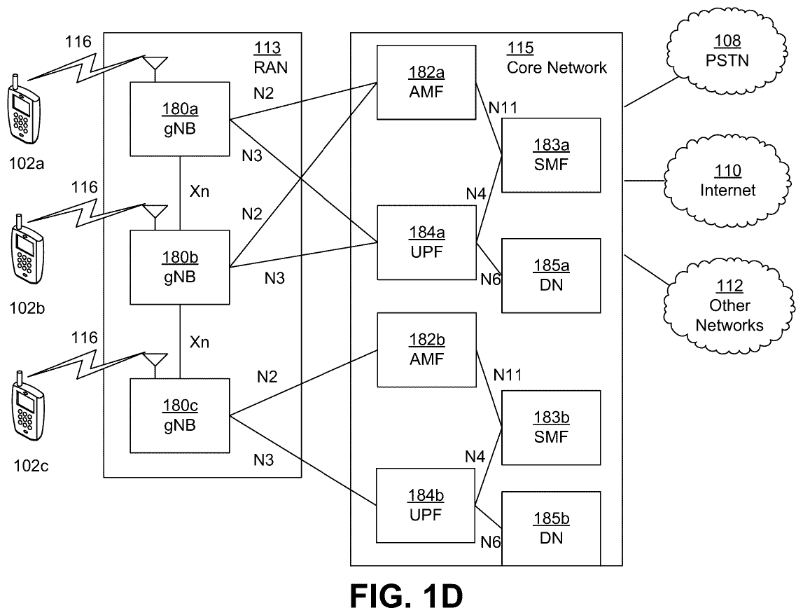

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The Node-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHZ, 80 MHZ, and/or 160 MHz wide channels. The 40 MHz, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more Node-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Overview

In certain representative embodiments, a sensing technology is provided (for example for a 6G network). The sensing technology may be used in 3rd Generation Partnership Project (3GPP). For example, 3GPP system features and capabilities may facilitate and enable sensing procedures and functions, such as for example the usage of existing signals (e.g., Positioning Reference Signal (PRS)) for performing sensing tasks (e.g., conducting measurements to determine whether an object or obstacle exists on the path where these signals propagate). In the 3GPP system, the main functions of a Channel State Information-Reference Signal (CSI-RS) may include the following: Channel State Information (CSI) reporting (Channel Quality Indicator (CQI), Rank Indicator (RI), Precoding Matrix Indicator (PMI)), beam management (refinement of initial Synchronization Signal Block (SSB) beam), connected mode mobility (handovers), Radio Link Failure (RLF) detection (in synch, out of synch indications), beam failure detection and recovery (indications to Medium Access Control (MAC)), and fine tuning of time and frequency synchronization (Tracking Reference Signal (TRS)). In addition, the key characteristics of CSI-RS may include: usage of up to 32 ports, periodic/semi-persistent/aperiodic scheduling, and Cyclic Delay Multiplexing (CDM), Time Division Multiple Access (TDM), and Frequency Division Multiple Access (FDM) configurations. In a 3GPP system, there may be three CSI-RS types and these may be follows: 1) Non-Zero Power Channel State Information Reference Signal (NZP CSI) (configured by CSI-ReportConfig), used for channel measurement and intra cell interference measurements; 2) Channel State Information-Interference Measurement (CSI IM) (configured by CSI-ReportConfig), used for inter cell measurements; 3) Zero Power Channel State Information Reference Signal (ZP CSI) (configured by PDSCH-Config), for rate matching (aligning bit count in a encoded segment with the available transmission resources) that may be used to allow scheduling of Physical Downlink Shared Channel (PDSCH) in a slot without causing interference to other channels. Legacy measurements, e.g., Channel State Information Reference Signal Received Power (CSI-RSRP), which may be used to capture CSI information to estimate the quality of the communication channel for transmission of information, and novel sensing related measurements, e.g., Angle of Arrival (AoA), delay, etc. may be performed over the resource elements (REs) allocated for CSI-RS. This may include measurements performed on a subset or the entirety of the allocated REs for a CSI-RS. In some cases, sensing measurements may be performed on CSI-RS resources repurposed for sensing. It should be noted that the sensing performance may improve by increasing the number of resources used for sensing.

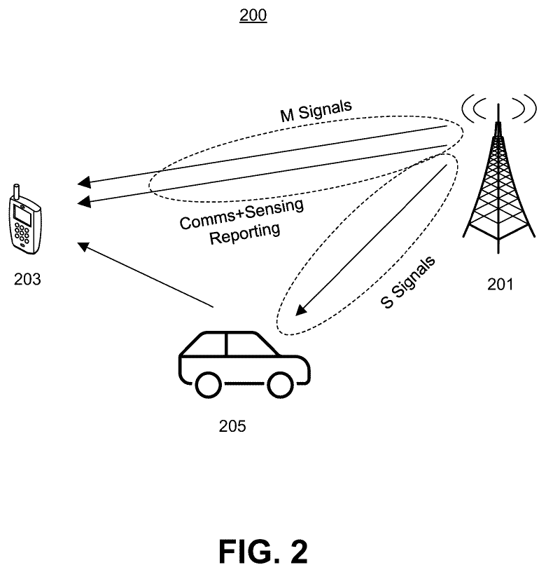

FIG. 2 illustrates a system 200 according to one or more embodiments. The system 200 comprises a gNB 201, a WTRU 203 and a sensing object 205. A number of CSI-RS signals may be transmitted from gNB 201 to WTRU 203 on resources. The resources may be split in sub-bands communication signals (M Signals) and sensing signals (S Signals). The communication signals and the sensing signals may be transmitted on the resources, and both communication and sensing reporting is enabled.

In certain representative embodiments, when CSI measurements are used for estimating a communication channel characteristics, there may be some cases for which increasing the number of resources on which Reference Signal (RS) are transmitted, may provide marginal incremental value in assessing the channel quality (such cases may also be identified using prediction mechanisms, for example AI-based). Using more resources may not be needed in such cases (e.g., in flat fading conditions, or when the channel's coherence bandwidth is larger than the allocated bandwidth for CSI RS) because the channel estimation may not be improved, and hence has no impact on the transmission performance. In such cases, it may be advantageous to repurpose some resources and transmit signals on these which may be used for sensing measurements. In certain representative embodiments, a WTRU may be enabled to use part (e.g., how many and which ones) of the CSI-RS resources for sensing.

Throughout the embodiments described herein, the network (NW) may include any of a base station (e.g. gNB, Transmission Reception Point (TRP), Radio Access Network (RAN) node, access node), core network function (e.g., AMF, SMF, Policy Control Function (PCF), Network Exposure Function (NEF)) and application function (e.g. edge server function, remote server function), for example.

Throughout the embodiments described herein, sensing information (or situational awareness information, or context awareness information) may refer to any information that describes perceptional phenomena about the physical environment (e.g., terrain information, obstacles or object that impact the wireless propagation characteristics, scenes, maps) and characteristics about the physical environment (materials, composition, etc.), for example.

Throughout the embodiments described herein, sensing object may refer to any physical objects that is not connected to the 3GPP system such as material objects (walls, buildings, structures, vehicles, etc.).

Throughout the embodiments described herein, sensing may refer to operation that uses 3GPP signals that are transmitted on defined 3GPP radio resources, and by performing measurements on the 3GPP signals, sensing information is ascertained. The performed measurements may include at least one of the following metrics: Reference Signal Received Power (RSRP), Reference Signal Received Quality (RSRQ), Angle of Arrival (AoA), Time of Arrival (ToA), delay, time difference between propagation paths, doppler measurements, as well as metrics derived from the multipath channel profile that contain information about the physical environment. The operation may include detection and estimation in the case when the knowledge regarding the physical environment is not a priori known, and it refers to detecting/estimating a sensing object, as defined above.

Throughout the embodiments described herein, sensing task may refer to a task that is based on generation and/or transmission of sensing information or any measurements and data relevant to the sensing information by a NW and/or a WTRU. Example of sensing task may include: detection of sensing objects by the NW and/or the WTRU based on measurements, detection of features and characterization of the physical environment, and exchange of sensing information by the NW and the WTRU for any sensing services.

Throughout the embodiments described herein, option for resource sub-bands may refer to configuration that defines a pattern on how to allocate CSI-RS resources between resources that are used for channel state estimation and resources that are used for sensing measurements.

Throughout the embodiments described herein, accuracy of the sensing task may refer to a quantitative value that indicates how accurately the sensing task has been performed. In one example, the sensing task may be detection of obstacles, then in the solution the accuracy of the sensing task may be the probability assigned to the presence of the obstacle. In certain representative embodiments, the accuracy of the sensing task may be expressed by metrics such as sensing resolution or sensing related measurements.

Throughout the embodiments described herein, channel state estimation may refer to the assessment of the condition of the channel which is required of optimization of transmissions using metrics such as CQI, PMI, and RI.

In certain representative embodiments a method is provided for using part of a CSI-RS resources for sensing as a function of the allocated CSI-RS resources and channel measurements on these resources.

In certain representative embodiments, a WTRU may receive, from a network (NW), in Radio Resource Control (RRC) message (e.g., RRC connection reconfiguration), at least one of the following: CSI-RS configuration, with information about the CSI-RS resources (e.g., frequency, time, Transmission Configuration Indication (TCI) states with Quasi-Colocation (QCL) information for channel state estimation and sensing tasks), CSI-RS resource sub-band configuration, e.g., containing options for using sub-bands of resources (e.g., time, code, frequency domain or combinations of these) associated with a time interval for which the usage is valid.

The WTRU may receive, from the NW, via RRC, at least one of the following: measurement configurations for channel estimations and for sensing measurements (e.g., metrics to measure on the signals transmitted on the CSI-RS resources), trigger conditions (i.e. at least one first criterion) and sensing task thresholds (i.e. at least one second criterion) for transmitting sub-band request, an example trigger condition may be if multiple sub-band options for the CSI-RS resources provide the same channel estimation performance, then select the option(s) with the highest percentage of sensing resources. An example of a sensing task threshold may be if selected option(s) provide sufficient resources to meet the accuracy of a sensing task threshold (e.g., probability that obstacle(s) is/are present in percentage), then threshold is met.

The WTRU may perform channel estimation measurements on all configured CSI-RS resources.

The WTRU may determine, at least one of the following: a) resource sub-band options based on the configurations, the trigger conditions, and the channel estimation measurements. For example, the WTRU may determine that an option with 50% of the resources provides channel state estimation equal to using all configured CSI-RS resources. b) Subset of the options based on the determined resource sub-band options and the sensing task threshold. For example, the WTRU may determine that an using only 50% and above of the sensing resources is sufficient to meet the sensing task threshold.

The WTRU may transmit, to the NW (e.g., gNB), at least one of the following: a) if trigger condition and the sensing task threshold are met., a sub-band request containing the determined options and the subset of options for the resources, and the measurements for meeting the trigger condition and the sensing task threshold. b) in all other cases a sub-band indication containing cause for not meeting the trigger conditions and/or the sensing thresholds.

### Initial Configuration

In certain representative embodiments, a WTRU may receive CSI-RS configuration for the purpose of performing channel estimation by performing measurements (e.g., RSRP measurements) on CSI-RS signal transmitted on CSI resources. The CSI-RS configuration may contain parameters defining the characteristics of the reference signals for channel measurements (e.g., CSI measurements such as RSRP, RSRQ, Signal-to-Interference-plus-Noise Ratio (SINR)), and the configuration may contain at least one of the following parameters: CSI-RS resource configurations (time and frequency resources), CSI-RS antenna ports, subcarrier spacing, bandwidth part configurations, CSI-RS density. The CSI-RS resource sets references to one or several configured CSI-RS and are used as a part of report configurations describing measurements and reporting done by the WTRU. In certain representative embodiments, CSI-RS may be transmitted with aperiodic, periodic, semi-persistent transmission, and there are three types: CSI-IM (resources used for WTRU's interference measurements from neighbouring cells), ZP-CSI-RS (resources where the PDSCH is not mapped), and NZP-CSI-RS (resources used for channel measurement, beam management and measurement).

In certain representative embodiments, a CSI-RS resource sub-band configuration may be part of the CSI-RS configuration, whereas in other representative embodiments, it may be separate configuration. In both cases, it may be transmitted to the WTRU via RRC, for example in RRC connection reconfiguration message. The sub-band configuration may contain information on options for splitting the CSI-RS resources, i.e., how many and which ones to be used for channel estimation, and how many and which ones to be used for sensing. The splitting may be done across multiple domains such as time, frequency, or using codes. In certain representative embodiments, these options may be expressed as percentages of contiguous resources (or non-contiguous), and associated with a time duration for which the option is valid where the time duration may be expressed as time slots or time intervals or symbol durations. Table 1 shows few example options for splitting the resources in sub-bands, namely option ID=1 and Option ID=2.

TABLE 1
Options for resource sub-bands

| Option ID, | REs for channel | REs for | Time |
|---|---|---|---|
| pattern | estimation [%] | sensing [%] | duration |
| 1, contiguous | 50 | 50 | 2 slots |
| 2, contiguous | 25 | 75 | 1 slot |

In certain representative embodiments, time-domain (TDM) and code-domain split (via cover codes) may be provided. The preference for one or the other type may depend on the TCI states configured by the network for both channel estimation and sensing tasks. Further, it can be noted that the number of antenna ports for channel estimation (up to 32) may differ from those for sensing. The sub-band options only impact the subset of antenna ports for CSI estimation that are repurposed for sensing, leaving the remaining ones unchanged. In certain representative embodiments, the options in Table 1 for splitting the resources may be received from multiple TRPs or multiple gNBs, in which case the WTRU needs to consider which option to select and from which TRP or gNB node.

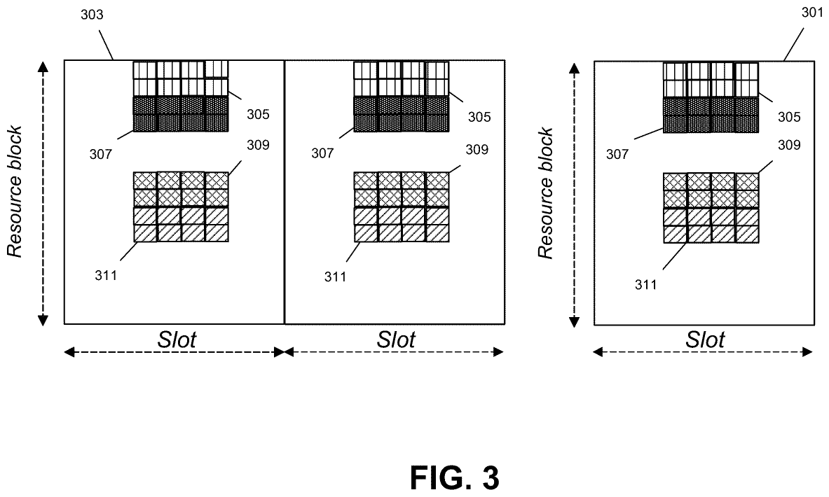

FIG. 3 illustrate exemplary CSI-RS structure according to one or more embodiment. A first CSI-RS structure 301 may comprise a single slot and a second CSI-RS structure 303 structure may comprise a double slot. The CSI-RS structures 301, 303 may comprise 8×CDM and 4× frequency mux, within a resource block/slot. Each slot may comprise a first type of CSI-RS 305, a second type of CSI-RS 309 and a third type of CSI-RS 311. Each slot may further comprise a Demodulation-Reference Signal (DM-RS) 307. The first, second and third type of CSI-RS 305, 309, 311 may be any one of CSI-IM, ZP-CSI-RS or NZP-CSI-RS. In certain representative embodiments, in the CSI-RS structure 311, the first type of CSI-RS 305 and the DM-RS 307 may be resource elements (REs) for channel estimation and the second type of CSI-RS 309 and the third type of CSI-RS 311 may be REs for sensing i.e., 50% of the available resource may be the part of resources used for channel estimation and, 50% of the available resources is the part of resources used for sensing. This configuration may correspond to option-ID=1 in Table 1. In certain representative embodiments, in the CSI-RS structure 301, the first type of CSI-RS 305 may be resource elements (REs) for channel estimation and the DM-RS 307, the second type of CSI-RS 309 and the third type of CSI-RS 311 may be REs for sensing i.e., 25% of the available resource may be the part of resources used for channel estimation and, 75% of the available resources is the part of resources used for sensing. This configuration may correspond to option-ID=2 in Table 1.

### Measurements, Trigger Conditions and Thresholds

The WTRU may receive from the NW, for example via RRC message, the following configurations: a) 3GPP measurements configurations such as measurement resources, objects, reporting configurations and associated identities used for the purpose of channel estimation. The measurement resources may be specifically dedicated resources by the NW to perform measurements. The measurement objects, reporting configurations and identities associating the objects and the reporting configurations may be configured by the NW in multiple combinations such as: one identity that links one object with multiple reporting configurations, or multiple objects with one reporting configuration, or multiple identities linking multiple objects and multiple configurations. The measurements may be performed on the CSI signals and the transmission resources used for the CSI signal transmission, and these may be at least one of the following: CSI-RSRP, CSI-RSRQ, CSI-SINR. b) 3GPP and non-3GPP localization measurement configurations, such as measurement resources, objects, reporting configurations and associated identities, used for the purpose of sensing. These measurement configurations may enable localization information such as WTRU positions, 3D orientation, coordinates, as well as information obtained from non-3GPP applications, cameras, lidars, sensing with 3GPP signals (bi-static and/or monostatic with reference signals such as PRS, DM-RS, CSI-RS, SSR, etc.) wherein the information may refer to any of the following metrics: resolution, range, accuracy, environmental information, mobility/velocity of objects, etc.

The WTRU may receive the trigger conditions (i.e. at least one first criterion) and sensing task accuracy thresholds (i.e. at least one second criterion). The WTRU may receive the trigger conditions (i.e. at least one first criterion) and sensing task accuracy thresholds (i.e. at least one second criterion) via RRC and these may be part of the aforementioned configuration, or may be configured via a separate RRC message. The trigger conditions and the sensing task accuracy thresholds may be configured for the purpose of selecting a sub-band option and for deciding whether the WTRU should transmit a sub-band request. The trigger conditions are associated with the selection of options (such as options exemplified in Table 1), whereas the transmission of the sub-band request is associated with the sensing task accuracy thresholds.

An example of trigger condition for the case of two available options in Table 1, may be the case when the two options for the CSI-RS resources provide the same channel estimation performance, then the option that allows usage of higher percentage of the sensing resources may always be selected. The condition: ‘If there are multiple options with different REs for channel estimation that provide the same channel estimation performance’ may mean that with the resources in the different options that are dedicated for channel estimation, the WTRU may obtain the same knowledge/channel estimation performance about the communication channel. More comprehensive examples (via measurements and illustrations) on how the WTRU can determine whether this condition is met is provided below. In the case when the above condition is met, then the following trigger conditions for selection of options from Table 1 may be generalized as provided below:

a) select one with the highest number of REs for sensing. b) select configurable number of options (for example top 3) that have the highest number of REs for sensing. c) select an option that has a number of REs for sensing above configurable threshold (for example 10%). d) select one with the lowest number of REs for sensing (in this case the NW may do initial sensing probe and wants to save resources). c) select configurable number of options (for example bottom 3) that have the lowest number of REs for sensing (similar usage to the previous case). f) select an option that has a number of REs for sensing below configurable threshold (for example 10%). g) select an option that has a number of REs for sensing between a configurable interval of thresholds (for example, above 10% and below 40%). h) select only contiguous options for the REs for sensing. i) select only non-contiguous options for the REs for sensing. j) select options that provide highest sensing task accuracy. k) select options that provide the lowest sensing task uncertainty range. 1) select options that provide sensing accuracy and/or uncertainty range above/below a certain configured threshold. m) any combination of the above.

An example of sensing task threshold may be expressed via probability that a sensing task (for example detecting an obstacle) has a threshold of 80%. In this case, the WTRU may need to (for example, based on measurements and implementation algorithms or models) determine whether the likelihood of obstacle presence is 80% for the configured sensing task threshold to be met. The sensing task threshold may be associated to the accuracy of the sensing task, number of measurements for the sensing task, and measurements within a certain time period for sensing. Few examples of sensing task accuracy thresholds are generalized below:

a) accuracy of the sensing task is below a probability threshold. b) accuracy of the sensing task is above a probability threshold. c) accuracy of the sensing task is between a probability threshold interval. d) number of measurements for the sensing task is below a threshold. c) number of measurements for the sensing task is above a threshold. f) number of measurements for the sensing task is between threshold interval. g) time duration for the measurements for the sensing task is below a threshold. h) time duration for the measurements for the sensing task is above a threshold. i) time duration for the measurements for the sensing task is between threshold interval. j) uncertainty range of the sensing task is below a probability threshold. k) any combination of the above.

In certain representative embodiments, the accuracy mentioned in the examples above may be linked to particular sensing related parameter (such as delay, doppler, etc.). More comprehensive examples (via measurements and illustrations) on how the WTRU may determine whether this threshold is met is provided below.

### Channel Estimation Measurements

In certain representative embodiments, for both Frequency Division Duplex (FDD) and Time Division Duplex (TDD), the gNB may transmit CSI-RS on the allocated REs, and the WTRU may make channel measurements on these signals and transmits a feedback information about the measured channel to the gNB. The transmitted CSI-RS may be confined to a bandwidth part (BWP). In the frequency domain, the CSI-RS may be transmitted every resource block (density=1), every 2 resource blocks (density=½), and Tracking Reference Signal (TRS), with density=3). In the time domain, the CSI-RS may be periodic (transmitted every Nth slot), semi-persistent (configured like the periodic case, but CSI-RS transmission may be be switched off and switched on), and aperiodic (CSI-RS transmissions are triggered when required using DCI). A specific time/frequency location table defines where in the slot the CSI-RS are sent, as well as the CDM options, and the specific time/frequency location table may contain information about the ports, the density, and the CDM-type. Ports (1 to 32) correspond to a sounding channel, density shows the number of REs allocated to the CSI-RS per RE per port, and CDM-type is only used when multiple ports share the same RE allocation.

The WTRU may measure the channel using the received CSI-RS and use the signal to estimate channel conditions by analyzing the received signal strength and phase. The CSI-RS may be used to measure CSI, e.g., CQI, PMI, CRI, SS/PBCH block resource indicator (SSBRI), layer 1 indicator (L1), RI, L1-RSRP. The WTRU may report back the information for the estimated channel state information, for example the most suitable precoding matrix for gNB to use which is selected from a codebook of matrices and indicated with the Precoding Matrix Indicator (PMI). There may be two types of codebooks: Type 1 (coarser, mostly for single user) and Type 2 (more extensive and used for multi-user MIMO). The CSI report can be transmitted in data and control channels, PUSCH or PUCCH, where the PUSCH reporting is triggered by DCI, and this may depend on the received CSI-RS configuration (periodic, semi-persistent, or aperiodic). The CSI report contains the measurements made by the WTRU such as: CQI, CSI-RS resource indicator, Rank Indicator, Layer Indication, Precoding Matrix Indicator, L1-RSRP, SS/PBCH Block Resource Indicator (SSBRI). The CSI report may be used by the gNB, but the gNB may nit select according to what is in the report (for example, the gNB does not have to use the precoding matrix indicated in the report).

### Determination of Sub-Band Options

In certain representative embodiments, the determination of sub-band options may be a two-step process. In the first step, the WTRU may determine options based on the measurements, the CSI-RS sub-band configurations, the configured triggered conditions. The CSI-RS sub-band configurations contain all supported options for splitting of the resources, as exemplified in Table 1. In certain representative embodiments, the WTRU may determine the options for splitting the resources. In certain representative embodiments, the WTRU may be configured (via RRC with CSI-RS sub-band configurations) with three contiguous (an extension of this option may be whether these are contiguous in time or frequency or both) options (Option ID=1, Option ID=2, Option ID=3), all defined with time duration of 2 slots, and in each option the number of REs for channel estimation decreases (75%, 50%, and 25%) and consequently, the number of REs for sensing increases (25%, 50%, and 75%), respectively, for option ID=1, option ID=2, option ID=3. The options are shown in Table 2. A trigger condition (i.e. at least one first criterion) may be to select options with the number of REs for sensing below or equal to 50% from the options that provide the same channel estimation performance.

TABLE 2
Example of sub-band options

| Option ID, | REs for channel | REs for | Time |
|---|---|---|---|
| pattern | estimation [%] | sensing [%] | duration |
| 1, contiguous | 75 | 25 | 2 slots |
| 2, contiguous | 50 | 50 | 2 slots |
| 3, contiguous | 25 | 75 | 2 slots |

### Determination of the Same Channel Estimation Performance

In certain representative embodiments, the WTRU may perform channel estimation using all allocated CSI resources to perform measurements and report back to the gNB feedback information about the channel in a form of a CSI report that contains the following CSI information: CQI, PMI, CRI, SS/PBCH block resource indicator (SSBRI), layer 1 indicator (L1), RI, L1-RSRP. The WTRU may need to determine for each of the options given in Table 2, whether using the REs for channel estimation for creating the CSI information will result in the same channel estimation performance as in the case when all allocated CSI resources were used. In one example, the WTRU may measure the L1-RSRP=−65 dBm on all resources for duration of two slots, and then the WTRU may need to determine whether measurements performed on 75% (option 1), 50% (option 2), and 25% (option 3) of the resources would results in L1-RSRP=−65 dBm. In the determination step, the WTUR may identify all options for which the previous condition is true. In another example, the comparison may be done using a margin, for example 2 dB margin, hence if measurements on all CSI-RS resources results L1-RSRP=−65 dBm, the WTRU may need to find the options for which the L1-RSRP measurement will be in the interval [−63 dBm, −67 dBm]. In certain representative embodiments, the comparison step may be done based on the CSI report content, i.e., to compare the CSI report obtained when all resources were used with the content of the CSI report when the configured options are used for generating CSI report. In this case, the WTRU may need to determine the options for which the CSI report will be the similar compared to the CSI report generated with all allocated CSI resources. The comparison of the report or even the measurements may be done by a WTRU implementation algorithm or model, however in all cases, the output of the comparison should be options from Table 2, i.e., options that provide number of REs for channel estimation that enables the same channel estimation performance to the case when all CSI-RS resources are used. In certain representative embodiments, these may be options ID=1 and options ID=2, i.e., using 75% and 50% of the RE for channel estimation provide the same channel estimation performance. These may be then checked against the trigger condition (note that in this example, the trigger condition is that options that provide REs for sensing below and equal to 50% meet the trigger condition) and since both meet the trigger condition, then option ID=1 and option ID=2 are passed on to the second step of the determination.

In the second step, the WTRU may determine subset of the options based on the sensing task (for example, detecting an obstacle) and the associated threshold. The WTRU may use the passed-on options from the first step, and the WTRU may determines whether the configured sensing task threshold is met for these options. In certain representative embodiments, the sensing task threshold may be given via the accuracy of the sensing task expressed via probability value (in percentage). Hence, the WTRU may estimate and determine whether the passed-on option ID=1 and option ID=2, i.e., using the 25% REs for sensing and using the 50% of REs for sensing can result in meeting the sensing task threshold (e.g., 80%). This may be done via implementation algorithm or model such as AI based models or empirical models. In certain representative embodiments, using such a model, the WTRU may determine that option ID=1 does not provide sufficient resources for sensing to reach the threshold, whereas option ID=2 provides sufficient resources for sensing to reach the threshold. The WTRU may include option ID=2 in the subset of the sub-band options.

### Transmission of Sub-Band Request and Indication

In certain representative embodiments, the WTRU may transmit, to the NW, for example towards the gNB, a sub-band request in the case when the trigger condition and the sensing accuracy thresholds are met, whereas in all other cases such as trigger condition met, but sensing task threshold not met, and trigger condition not met (hence sensing task threshold can not be met), the WTRU may transmit a sub-band indication containing cause for not sending sub-band request (for example, information that no trigger conditions were met, or information indicating that trigger condition was met, but sensing task threshold was not met).

In certain representative embodiments, the sub-band request and/or the sub-band indication may be transmitted jointly with the CSI-RS report. In certain representative embodiments, the sub-band request and/or the sub-band indication may be transmitted in a separate uplink feedback message.

The sub-band request may contain at least one of the following information: a) options for resources sub-band as determined in the first step discussed above. b) Subset of options for the resources sub-band as determined in the second step discussed above. c) the measurements obtained for meeting the trigger conditions in the first step discussed above. d) Measurements, models, algorithms used for meeting the sensing task thresholds in the second step discussed above. The WTRU may determine subset of the options based on the sensing task (for example, detecting an obstacle) and the associated threshold as configured and discussed above.

The sub-band indication may contain at least one of the following information: a) Measurements, models, algorithms used to confirm if trigger conditions are true or false, and identification information for these trigger conditions. b) Measurements, models, algorithms to confirm that sensing task thresholds are not met, and identification information for these thresholds.

In addition, the sub-band indication may be transmitted as a flag with additional condition that indicates which of the thresholds or trigger conditions did not meet the requirements.

Upon transmitting the sub-band request to the NW, the WTRU may receive configurations from the NW where all CSI-RS resources are partitioned to resources used for channel state estimation and to resources used for sensing measurements.

Upon transmitting the sub-band indication to the NW, the WTRU may receive a new set of initial configurations as provided above.

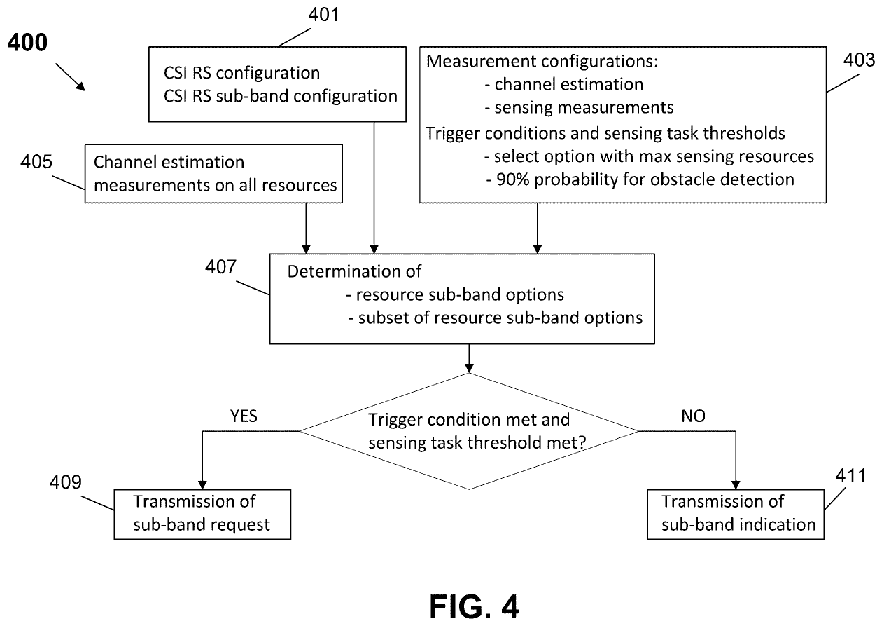

FIG. 4 is a flow chart illustrating a process 400 according to one or more embodiment. A WTRU may receive prior to a channel estimation measurement step a plurality of configuration information. For example, the WTRU may receive CSI-RS configuration and CSI RS sub-band configuration at step 401, measurements configurations as well as trigger conditions and sensing task thresholds at step 403. The CSI-RS configuration may indicate all the CSI resources used for the channel estimation measurements, whereas the CSI RS sub-band configuration may contain options for potential splitting of the resources in different domains (time, frequency, codes). The measurements configurations may be used for performing both channel estimation and sensing related measurements, whereas the trigger conditions and sensing task thresholds are configurable at the WTRU and needed for the determination steps. Once the channel estimation measurements on all resources is completed at step 405, the WTRU may initiate the determination step 407 using all the inputs received at steps 401, 403 and 405. The determination step 407 may identify options for splitting the resources, i.e., resource sub-band options as well as subset of these such that these meet the trigger conditions and the sensing task thresholds. In certain representative embodiments, the trigger condition may contain information to always select an option with max sensing resources from all the available ones, whereas if the referent sensing task is obstacle detection, then an example sensing task threshold may be whether with 90% probability the obstacle can be detected using the sensing resources. If the trigger condition and sensing task thresholds are met, at step 409, the WTRU may transmit a sub-band request for splitting of the resources such that part of the resources are used for channel estimation measurements and the other part are used as sensing resources. If the trigger condition and sensing task thresholds are not met, at step 411, the WTRU may transmit a sub-band indication that informs the network that the WTRU is not able to identify suitable option for splitting the resources as well as information from the determination step 507 such as how close was the WTRU to the threshold and/or the performed measurements.

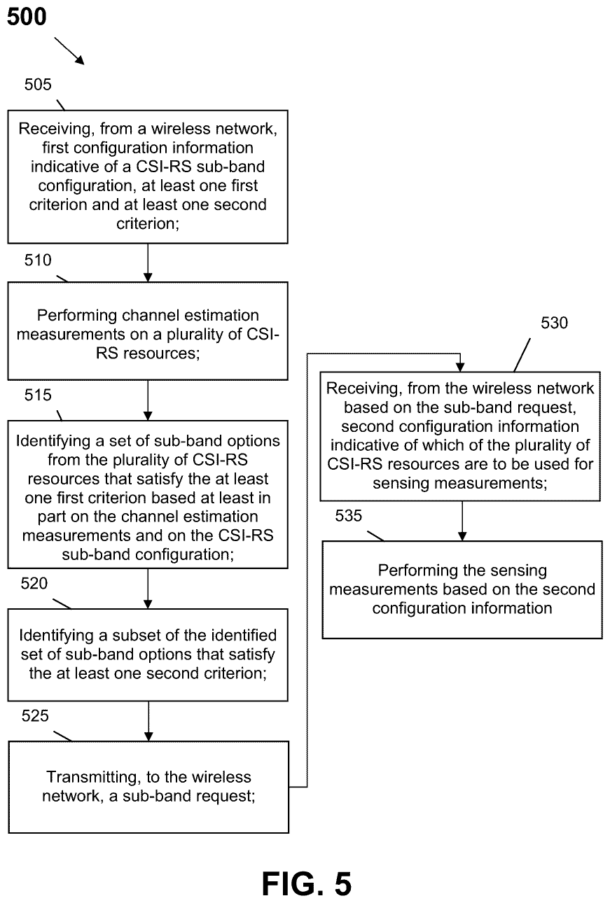

FIG. 5 is a flow chart illustrating a method 500 for dynamic allocation of CSI resources for sensing according to one or more embodiment. The method 500 may be performed by a wireless transmit/receive unit (WTRU). The method 500 may include receiving 505, from a wireless network, first configuration information indicative of a Channel State Information-Reference Signal (CSI-RS) sub-band configuration, at least one first criterion and at least one second criterion. The method 500 may include performing 510, channel state estimation measurements on a plurality of CSI-RS resources. The method 500 may include identifying 515, a set of sub-band options from the plurality of CSI-RS resources that satisfy the at least one first criterion based at least in part on the channel state estimation measurements and on the CSI-RS sub-band configuration. The method 500 may include identifying 520, a subset of the identified set of sub-band options that satisfy the at least one second criterion. The method 500 may include transmitting 525, to the wireless network, a sub-band request. The method 500 may include receiving 530, from the wireless network based on the sub-band request, second configuration information indicative of which of the plurality of CSI-RS resources are to be used for sensing measurements. The method 500 may include performing 535, the sensing measurements based on the second configuration information.

In some implementations, the second configuration information may indicate a second plurality of CSI-RS resources to be used for sensing measurements different from the plurality of CSI-RS resources on which the channel state estimation was performed. The wireless network may configure the WTRU with the second plurality of CSI-RS resources.

In some implementations, sensing information based at least in part on the sensing measurements is transmitted to the wireless network.

In some implementations, the at least one first criterion comprises at least one of: a highest number of Resource Element (RE) for a sensing task, a highest sensing task accuracy and/or a lowest uncertainty range in a sensing task.

In some implementations, the at least one second criterion comprises at least one of: an accuracy associated with a sensing task, number of measurements for a sensing task or a time duration for measurements for a sensing task, with respect to a probability threshold.

In some implementations, the sub-band request comprises information associated with at least one of the identified set of sub-band options, the identified subset of the set of sub-band options, the channel state estimation measurements, the at least one first criterion, or the at least one second criterion.

In some implementations, the first configuration information is further indicative of at least one of channel state estimation measurement configuration, sensing measurement configurations, CSI-RS configuration, or the set of sub-band options.

In some implementations, the second configuration information comprises information indicative of which of the plurality of CSI-RS resources are to be used for channel state estimation.

8. The method of claim 3, wherein:

In some implementations, the sensing task comprises performing measurements on at least one of the plurality of CSI-RS resources, wherein the at least one of the plurality of CSI-RS resources is one of CSI-RS resources or sensing resources.

The contents of the following reference is incorporated by reference herein in their entireties: [1] TR 22.837.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method performed by a wireless transmit/receive unit (WTRU), the method comprising:
receiving, from a wireless network, first configuration information indicative of a Channel State Information-Reference Signal (CSI-RS) sub-band configuration, at least one first criterion and at least one second criterion;
performing channel state estimation measurements on a plurality of CSI-RS resources;
identifying a set of sub-band options from the plurality of CSI-RS resources that satisfy the at least one first criterion based at least in part on the channel state estimation measurements and on the CSI-RS sub-band configuration;
identifying a subset of the identified set of sub-band options that satisfy the at least one second criterion;
transmitting, to the wireless network, a sub-band request;
receiving, from the wireless network based on the sub-band request, second configuration information indicative of which of the plurality of CSI-RS resources are to be used for sensing measurements; and
performing the sensing measurements based on the second configuration information.

2. The method of claim 1, further comprising:
transmitting, to the wireless network, sensing information based at least in part on the sensing measurements.

3. The method of claim 1, wherein:
the at least one first criterion comprises at least one of: a highest number of Resource Element (RE) for a sensing task, a highest sensing task accuracy and/or a lowest uncertainty range in a sensing task.

4. The method of claim 1, wherein:
the at least one second criterion comprises at least one of: an accuracy associated with a sensing task, number of measurements for a sensing task or a time duration for measurements for a sensing task, with respect to a probability threshold.

5. The method of claim 1, wherein:
the sub-band request comprises information associated with at least one of the identified set of sub-band options, the identified subset of the set of sub-band options, the channel state estimation measurements, the at least one first criterion, or the at least one second criterion.

6. The method of claim 1, wherein:
the first configuration information is further indicative of at least one of channel state estimation measurement configuration, sensing measurement configurations, CSI-RS configuration, or the set of sub-band options.

7. The method of claim 1, wherein:
the second configuration information comprises information indicative of which of the plurality of CSI-RS resources are to be used for channel state estimation.

8. The method of claim 3, wherein:
the sensing task comprises performing measurements on at least one of the plurality of CSI-RS resources,
wherein the at least one of the plurality of CSI-RS resources is one of CSI-RS resources or sensing resources.

9. A wireless transmit/receive unit (WTRU) comprising:
a processer, and
a transceiver coupled to the processer, wherein the WTRU is to:
receive, from a wireless network, first configuration information indicative of a Channel State Information-Reference Signal (CSI-RS) sub-band configuration, at least one first criterion and at least one second criterion;
perform channel state estimation measurements on a plurality of CSI-RS resources;
identify a set of sub-band options from the plurality of CSI-RS resources that satisfy the at least one first criterion based at least in part on the channel state estimation measurements and on the CSI-RS sub-band configuration;
identify a subset of the identified set of sub-band options that satisfy the at least one second criterion;
transmit, to the wireless network, a sub-band request;
receive, from the wireless network based on the sub-band request, second configuration information indicative of which of the plurality of CSI-RS resources are to be used for sensing measurements; and
perform the sensing measurements based on the second configuration information.

10. The WTRU of claim 9, wherein the WTRU is further to:
transmit, to the wireless network, sensing information based at least in part on the sensing measurements.

11. The WTRU of claim 9, wherein:
the at least one first criterion comprises at least one of: a highest number of Resource Element (RE) for a sensing task, a highest sensing task accuracy and/or a lowest uncertainty range in a sensing task.

12. The WTRU of claim 9, wherein:
the at least one second criterion comprises at least one of: an accuracy associated with a sensing task, number of measurements for a sensing task or a time duration for measurements for a sensing task, with respect to a probability threshold.

13. The WTRU of claim 9, wherein:
the sub-band request comprises information associated with at least one of the identified set of sub-band options, the identified subset of the set of sub-band options, the channel state estimation measurements, the at least one first criterion, or the at least one second criterion.

14. The WTRU of claim 9, wherein:
the first configuration information is further indicative of at least one of channel state estimation measurement configuration, sensing measurement configurations, CSI-RS configuration, or the set of sub-band options.

15. The WTRU of claim 9, wherein:
the second configuration information comprises information indicative of which of the plurality of CSI-RS resources are to be used for channel state estimation.

16. The WTRU of claim 11, wherein:
the sensing task comprises performing measurements on at least one of the plurality of CSI-RS resources,
wherein the at least one of the plurality of CSI-RS resources is one of CSI-RS resources or sensing resources.
